(19) United States
(12) Patent Application Publication
(10) Pub. No.: US 2022/0246932 A1
(43) Pub. Date: Aug. 4, 2022

(54) ELECTRODE, ELECTRICAL ENERGY STORAGE DEVICE & METHOD

(71) Applicant: INSTITUTT FOR ENERGITEKNIKK, Kjeller (NO)

(72) Inventors: Alexey KOPOSOV, Oslo (NO); Jan Petter MÆHLEN, Frogner (NO); Asbjørn ULVESTAD, Oslo (NO)

(21) Appl. No.: 17/621,730

(22) PCT Filed: Jun. 24, 2020
(86) PCT No.: PCT/EP2020/067595

§ 371 Date: Dec. 22, 2021

(30) Foreign Application Priority Data
Jun. 24, 2019 (NO) 20190792

(51) Int. Cl. H01M 4/58; H01M 4/48; H01M 4/62; H01M 10/0525; H01M 10/36; H01M 4/36

(52) U.S. Cl. CPC H01M 4/58; H01M 4/48; H01M 4/624; H01M 2004/021; H01M 10/36; H01M 4/366; H01M 10/0525

(57) ABSTRACT

Electrode (24) for an electrical energy storage device, which electrode (24) comprises an electrode active material layer (10) containing a plurality of particles of modified electrode active material comprising amorphous or crystalline, micro- or nano-sized stoichiometric or non-stochiometric silicon nitride each having a chemical formula of SiNx whereby 0 to 30% of said particles (12) contain one or more modifying elements selected from the group: phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb), and arranged in a conductive electrode matrix (14) so as to exhibit at least one of the following: a) a chemical composition gradient, whereby the nitrogen content within the particles (12) increases or decreases with distance from a surface (16) of the electrode active material layer (10), and/or b) a particle size gradient, whereby the average particle size of the particles of modified electrode active material (12) increases or decreases with distance from a surface (16) of the modified electrode active material (10) and/or c) a chemical composition gradient, whereby said modifying element content changes through the thickness of the modified electrode active material (10).

### TECHNICAL FIELD

The present invention concerns an electrode for an electrical energy device, which electrode comprises a modified electrode active material containing a plurality of particles comprising amorphous or crystalline, micro- or nano-sized, stoichiometric or non-stochiometric silicon nitride-based materials. The present invention also concerns an electrical energy storage device, such as a lithium-ion battery, a sodium-ion battery, or a potassium-ion battery, that contains at least one such electrode.

### BACKGROUND OF THE INVENTION

Electrochemical batteries for energy storage can be produced in many ways. Currently, the battery chemistry seeing the fastest growth is the lithium-ion battery. The key elements of this technology are the electrodes: anode and cathode, where oxidation and reduction chemistry take place, an electrolyte enabling ion migration between the two electrodes internally inside the battery, a separator preventing short circuiting inside the battery, and current collectors providing the external electrical connection to the system. During the charge and discharge of the battery, lithium-ions migrate through the electrolyte from cathode material to anode material and back. During this process lithium-ions penetrate inside one electrode's active material while leaving the other. This could be either intercalation through the crystal structure (common for cathode materials) or formation of an alloy (e.g. occurs with some anode materials). To preserve the electric charge balance of the battery, a current of electrons is established through the current collectors to balance the transport of the positively charged lithium-ion transport.

An electrode is usually fabricated in the shape of a film comprising the active material that interacts with the lithium, participates in storage of lithium and charge transfer processes associated with oxidation or reduction of lithium; a binder that preserves the integrity of an electrode by ensuring the adhesion of active material within the electrode, and often a conductive additive, such as graphite or other carbon-based materials, to provide extra electron conductivity within the electrode. All abovementioned components, including active material are typically introduced into the electrode preparation process in the form of a powder.

Silicon, in general, is considered to be a very promising active material for anodes of lithium-ion batteries due to its very high theoretical lithium absorption capacity reaching up to 4.4 lithium atoms per silicon atom. However, silicon, in its pure form, suffers from structural degradation during cyclic charging and discharging due to constant expansion and contraction driven by lithiation/de-lithiation resulting in performance losses. Silicon expands by up to 400% during the intake of lithium (which could be viewed as alloying with lithium), and contracts during its extraction, meaning that for each cycle of charging and discharging of the battery, the silicon will expand and contract, and, due to finite diffusion of lithium in silicon, often at different rates in different locations of the same particle. This causes formation of stress which can lead to cracking and fracture of silicon particles, which expose new fresh surfaces of silicon. In addition, fracturing potentially compromises the internal electron conductivity of the particles and the electrode as a whole to the extent that some parts of the active material can become disconnected from the conductive network of the battery electrode, and thereby rendered inactive.

The exposure of new surfaces also leads to increased degradation of the electrolyte, the components of which are not necessarily stable in relation with the active material surface and therefore decompose. Ideally, the products of this decomposition form a passivating layer which prevents further reaction, often termed the Solid Electrolyte Interphase (SEI), the stability of which is paramount for the long-term operation of the battery. The formation of SEI is known to consume substantial amounts of electrolyte and active lithium within a battery. During the cycling of the battery, volumetric changes of silicon will cause fracture and delamination of the SEI layer, thereby exposing a clean surface. That leads to a formation of a new SEI-layer and continuous repetition of this process will lead to complete consumption of electrolyte and active lithium resulting in battery failure. In addition to the reported cracking/fracturing, it has also been acknowledged that under cycling silicon seems to become highly mobile and reorganizes itself into new structures possibly according to the lithium flows during lithiation and de-lithiation of the electrodes. This continuously exposes new surfaces to the electrolyte, and after long cycling, the surface to volume ratio of the silicon can increase significantly. Those newly formed surfaces serve as locations for interactions with the electrolyte, which results in further formation of SEI.

Thus, the degradation mechanisms described above will lead to constant exposure of new (fresh) large surface areas of silicon with unstoppable SEI layer formation and will correspondingly result in a large amount of electrolyte and lithium being consumed. The losses of electrolyte and mobile lithium lead to a rapid decrease of battery performance and complete failure of the battery after 50-150 cycles depending on the size, structure and morphology of silicon particles or bulk material used in the anode.

Some of prior art documents and studies have addressed the degradation problems outlined above by coating silicon particles and nanoparticles with organic or inorganic materials. The coating, which can be applied using a variety of methods, physically limits the particles' expansion, and/or delivers the opportunity of permanent electrical contact with silicon even upon fracturing. Inorganic coatings, which are usually applied using Atomic Layer Deposition (ALD) or solution-based chemistry, often provide good electric and ionic conductivity. However, the majority of inorganic coatings do not have the elasticity that is required for the expansion of the silicon structure. This may result in damage of the coating due to the coating fracturing, which leads to similar degradation mechanisms as for pure silicon although such coatings may substantially delay battery failure. If a coating does not undergo cracking, it may provide substantially better stability of the anode at the cost of the limited capacity, as a robust inorganic or organic coating will limit the expansion of the silicon and therefore the lithium intake and maintain the integrity of the active material and prevent “silicon migration”.

Carbon-based coatings are mostly represented by either mechanical coating with graphite and graphene or coating with organic molecules/polymers with subsequent carbonization. The use of graphene potentially delivers flexibility to the whole structure allowing complete expansion of coating material during lithiation. Application of graphite or graphene is typically performed through the grinding, milling, spray-drying or ball-milling techniques. Other carbon-based coating processes involve the formation of a carbon layer after an additional carbonization step. This is usually performed by mixing silicon particles with a polymer or performing polymerization in the presence of particles with further heating/annealing of the mixture in an inert atmosphere. The polymer decomposes forming a carbon/silicon composite.

US patent application no. US 2015/280222 discloses that the expansion of silicon will, however, break most coatings applied thereto, leading to fresh silicon surfaces being exposed. The high mobility of lithiated silicon will then lead to this fresh surface dominating further lithiation, and thereby degradation behavior. Sometimes it is attempted to mitigate the cracking by only partially lithiating an electrode, but this can lead to inhomogeneous lithiation as some particles experience high local resistance and are not lithiated as intended, while other particles are fully lithiated and thereby degrade more rapidly.

As an alternative to using pure silicon, a number of prior art documents proposed the use of silicon carbide, silicon oxide and silicon nitride materials to mitigate the failure mechanisms of the anode. The benefit of using such material is a different mechanism of their interaction with lithium. Specifically, during the first lithiation those materials undergo phase separation process with the formation of the matrix material with clusters of pure silicon embedded inside. The small clusters of silicon act as active material, while the surrounding matrix prevents mechanical fracturing caused by pulverization. Silicon nitride and others also could be utilized in a form of nanoparticles, which allows the traditional processing of anodes through slurry deposition as mentioned above. However, those materials also participate in the electrochemical interactions with electrolyte forming SEI layer.

To minimize the growth of the SEI layer it would be beneficial to minimize the area of interface between the active material of the electrode and electrolyte. In principle, due to a different lithiation mechanism, a material, such as silicon nitride, is less prone to cracking and fracturing, thus—larger particles would be beneficial to minimize the surface area and decrease SEI layer formation. Decrease of SEI layer formation would assist to minimize electrolyte and lithium consumption, thus, extending the battery lifetime. However, the relatively low electrical conductivity of silicon nitride implies a limitation of the particle size to ensure the conductivity of the electrode necessary for the battery functionality. Specifically, pure stoichiometric silicon nitride is an electrical insulator. Thus, when placed in battery anodes, particles with a high nitrogen content do not provide the expected performance in terms of internal resistance and capacity. High internal resistance may lead to poor lithiation and poor control of the material conversion into its active form which will ultimately limit the capacity of the anode.

In addition, the initial performance of silicon nitride is often severely diminished due to the electrochemically induced formation of the matrix material in which silicon particles are embedded. Such a matrix serves as a lithium and, possibly, electron conductor as well as prevents silicon migration. However, until the matrix is properly formed through the conversion reaction, the anode material cannot realize its full potential. Since matrix formation is an electrochemical process, proper electrical conductivity at very first cycle is essential for the conversion reaction to occur.

Furthermore, the battery active materials must have not only electronic conductivity, but also ionic conductivity and elasticity (or ability to keep the secondary conductive structure since the materials undergo expansion during lithiation and contraction during de-lithiation).

A promising solution to partial suppression of the degradation processes is to utilize small particles, which include nanoparticles (particles with a maximum transverse dimension up to 100 nm), and in some cases particles with a maximum transverse dimension up to several microns. Such an approach allows a solution-based processing of the anodes, when silicon nanoparticles are mixed together with conductive additives and binders in either water or organic solvent to form a slurry and then cast on a current collector to form an electrode. The particles of a reduced size (ideally, at nanoscale) are substantially less susceptible to mechanical damage caused by lithiation/de-lithiation during cycling as the mechanical stress caused by expansion/contraction is reduced with the reduction of particles' dimensions. Proper selection of the silicon nanoparticles, and components of the slurry's formulation results in an extension of the lifetime of the anode and prevents some of the intrinsic degradation of the silicon material.

Generally, the problem of achieving sufficient electrical conductivity in composite silicon-based anodes is addressed by using a suitable combination of conductive additives and binder materials which assist in establishing sufficient electrical conductivity throughout the anode. The rational selection of the size and appropriate coating of silicon-based nanoparticles also helps to mitigate low electrical conductivity. Generally, the use of small nanoparticles allows to mitigate the problem of high resistance; however, a large surface area negatively affects their initial performance due to SEI formation. For pure silicon minimization of the size of the particles also allows to mitigate fracturing of the material upon cycling. Therefore, for pure silicon particles and silicon-based materials, the selection of the material represents a tradeoff between high surface area (large SEI formation) with decreased electrical conductivity and high fracturing (for large particles).

For the alloyed materials, such as silicon nitride, fracturing does not represent a significant problem, due to a different mechanism of materials functionality, as briefly described above. However, the proper size selection of the silicon-based particles (such as silicon nitride) still represents a major challenge for the deployment of the technology based on silicon alloys. Briefly, it can be represented as a tradeoff between particle size and composition: larger particles are better for minimizing the SEI formation but have conductivity issues resulting in poor silicon/matrix transformation. In addition, higher nitrogen content assists in the matrix formation and extends the particles lifetime, but also diminishes conductivity and active material capacity. This does not allow highly desired particles of larger sizes (having a maximum transverse dimension above 100 nm) to be efficiently utilized.

The initial performance of silicon nitride is often severely diminished due to the electrochemically induced formation of matrix material in which silicon particles become embedded. Such a matrix serves as a lithium conductor and prevents silicon migration. However, until the matrix is properly formed, the anode material cannot utilize its full potential. Since matrix formation greatly depends on electrochemical reaction, proper electrical conductivity is essential for the conversion reaction. The desired capacity of anodes for future generations of lithium-ion batteries is above 1500 mAh/g. Thus, alternative compositions of similar materials generally result in substantially diminished capacity and are therefore not suitable as anode materials in lithium-ion batteries.

European patent no. EP 1,149,934 discloses a process in which low hydrogen-content silicon nitride-based materials are deposited by a variety of Chemical Vapour Deposition (CVD) techniques, preferably thermal CVD and plasma-enhanced CVD (PECVD), using chemical precursors that contain silicon atoms, nitrogen atoms, or both. A preferred chemical precursor contains one or more N—Si bonds. Another preferred chemical precursor is a mixture of a N-containing chemical precursor with a Si-containing chemical precursor that contains less than 9.5 weight % hydrogen atoms. A preferred embodiment uses a hydrogen source to minimize the halogen content of silicon nitride-based materials deposited by PECVD.

US patent application no. 2006/292445 A1 discloses a negative electrode for a lithium ion secondary battery including a current collector and an active material layer carried on the current collector, wherein the active material layer includes an active material and no binder, the active material contains silicon and nitrogen, and the active material layer has a larger nitrogen ratio on a side of a first face which is in contact with the current collector than on a side of a second face which is not in contact with the current collector.

PCT publication no. WO 2017/207525 A1 concerns a method for producing a powder comprising particles comprising amorphous, micro- or nano-crystalline silicon nitride. The method comprises the steps of supplying a reactant gas containing silicon, and a reactant gas containing nitrogen, to a reaction chamber of a reactor, and heating said reactant gases to a temperature in the range of 510° C. to 1300° C. which is sufficient for thermal decomposition or reduction of the reactant gases to take place inside the reaction chamber to thereby produce a powder of amorphous, micro- or nano-crystalline particles comprising silicon nitride (SiNx) in which the atomic ratio of silicon to nitrogen is in the range 1:0.2 to 1:0.9. The produced powder of particles may be used to produce a film, an electrode, such as an anode, for a battery, such as a Lithium ion battery.

The article by A. Ulvestad et al. entitled “Silicon Nitride Coated Silicon Thin Films as Anodes for Li-ion Batteries”, Institute for Energy Technology, Kjeller, No-2027, Norway, ECS Transactions (2015), 64 (22), 107-111 discloses that when using silicon in anodes for Li-ion batteries, there is a tradeoff between using small silicon structures to avoid cracking and having small surface area to reduce electrolyte degradation due to an unstable Solid Electrolyte Interface (SEI). To facilitate the growth of a stable and thin SEI, the authors proposed to coat silicon with a thin layer of silicon nitride. Silicon nitride by itself has been determined to function as a conversion electrode material, forming lithium nitride and elemental silicon during the initial lithiation. Using a thin film model system, the authors demonstrated the effect of using nitride coatings with different stoichiometry on the cyclability and high rate capacity of the electrodes. The results showed that a nitride coating has a positive effect on both the cycling stability and high rate performance.

The article by A. Ulvestad et al. entitled “Silicon nitride as anode material for Li-ion batteries: Understanding the SiNx conversion reaction”, Department of Battery Technology, Institute for Energy Technology, Kjeller, No-2027, Norway, Journal of Power Sources, (2018), 399, 414-421 describes the development of a model reaction which relates the reversible and irreversible capacities of an electrode to the composition of the conversion products. By fitting this model to experimental data from a large number of a-SiNₓ thin film electrodes with different thickness and composition, the authors determined with a high probability that the matrix composition was Li₂SiN₂. From this, the reversible and irreversible capacities of the material can be predicted for a nitride of a given composition.

### SUMMARY OF THE INVENTION

The object of the present invention is to provide an improved electrode comprising a modified electrode active material, which is suitable for use in an electrical energy storage device, such as a lithium-ion battery or, possibly, a sodium-ion battery or a potassium-ion battery (since the anodes for sodium- and potassium-ion batteries are often similar to the anodes for lithium-ion batteries), and which mitigates some of the degradation processes described above.

The objective is achieved by an electrode comprising the features recited in claim 1. The electrode that comprises a plurality of particles of a modified electrode active material comprising amorphous or crystalline micro- or nano-sized stoichiometric or non-stochiometric silicon nitride each having a chemical formula of SiNₓ, whereby 0 to 30%, or 0-20%, or 0-10% of the atoms in the particles are replaced by one or more modifying elements selected from the group: phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb). The particles are arranged in a conductive matrix or electrode so as to exhibit at least one of the following:

a) a chemical composition gradient, whereby the nitrogen content within the particles increases or decreases with distance from a surface of the electrode, i.e. the nitrogen content of the modified electrode active material changes through the thickness of the electrode, and/or

b) a particle size gradient, whereby the average size of the particles increases or decreases with distance from a surface of the electrode, and/or

c) a chemical composition gradient, whereby the modifying element content (but not the silicon nor nitrogen content) in the modified electrode active material changes through the thickness of the electrode when one or more of the modifying elements are present in the modified electrode active material.

The electrode namely comprises particles of the modified electrode active material having different compositions, whereby the particles have at least two different atomic ratios of silicon to nitrogen, i.e. different x values in the chemical formula of SiNₓ, and/or the particles have at least two different particle sizes that are arranged so as to show an increasing or decreasing nitrogen content and/or particle size, and/or the particles of the modified electrode active material have at least two different amounts of the third element substituting silicon or nitrogen or both, that are arranged so as to show an increasing or decreasing third element content.

If such modified electrode active material is used in an electrode in an electrical energy storage device, such as for the anode, of a lithium-ion battery for example, that will allow the use of the large particles of the modified electrode active materials without sacrifice of the internal resistance. Thus, due to decreased surface area of the modified electrode active material, solid-electrolyte-interphase (SEI) layer formation and electrolyte consumption will be significantly reduced compared to a conventional silicon extending the lifetime of the battery. Due to the different mechanism of material functionality, i.e. formation of silicon clusters in modified electrode active material, the SEI layer will form only on the primary particle surface. The modified electrode active material assists the lithiation/delithiation process as well as provided electric conductivity.

Furthermore, the proper arrangements of the particles of the modified electrode active material within the electrode of the electrical energy storage device by providing a gradient in either size or composition will deliver an additional tool to improve the conductivity thought the electrode, minimizing the amount of the conductive additives and assisting in uniform lithiation of the electrode. This will allow the amount of the active material utilized in the anode to be increased and other components to be decreased and, thus, improve the capacity.

The proposed electrode material is intended for electrical energy storage device applications, which comprise batteries based on different chemistries. While the core material, i.e. the unmodified electrode active material, is currently viewed as a material for Li-ion batteries, its modifications, such as the modified electrode active material described herein, are intended for use, not only in Li-ion batteries, but also in Na- or K-ion batteries. Specifically, such modified electrode active material can act as a conversion material for other battery chemistries as the presence of the modifying elements substantially changes the mechanisms of interaction between the active material and active ions in an electrochemical cell.

It should be noted that, even though a Li-ion battery is described as an example of an electrical energy storage device herein, this document also concerns other types of electrical energy storage device and not only Li-ion batteries.

According to an embodiment of the invention the electrode comprises spherical particles of the modified electrode active material having a diameter of 100 nm-5 μm.

According to an embodiment of the invention the electrode comprises particles of the modified electrode active material having an anisotropic shape with a minimum transverse dimension of 100 nm-5 μm.

According to an embodiment of the invention the electrode comprises particles of the modified electrode active material having a rod-like shape wherein the minimum transverse dimension of the particles is 100 nm-5 μm.

According to an embodiment of the invention the electrode comprises particles of the modified electrode active material in the form of platelets wherein the thickness of the particles is 100 nm-2 μm.

It should be noted that the electrode according to the present invention may comprise particles of the modified electrode active material having a plurality of different shapes and the dimensions given in this document refer to single particles in their coated or uncoated state.

According to an embodiment of the invention the particles of the modified electrode active material comprise silicon nitride in which the atomic ratio of silicon to nitrogen is in the range of 1:0.02 to 1:1.33, i.e. the silicon nitride in the particles has a chemical formula of SiNₓ where 0.02≤x<1.33, preferably in the range 1:0.02 to 1:0.9, whereby 0 to 30%, or 0-20%, or 0-10% of the atoms in the particles are replaced by one or more modifying elements selected from the group: phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb). The produced particles namely comprise silicon and nitrogen in the ratio 1:x and other elements. The value of x and the amount of the modifying element(s) is/are tuned to the lithium-absorption capacity desired for a particular application, such as for an electrode in which a trade-off between the conductivity of the particles, the lithium-absorption capacity of the particles, the expansion of the particles and the first cycle irreversible capacity of the particles needs has to be reached.

According to an embodiment of the invention the electrode comprises particles of a modified electrode active material which contain up to 10 atomic % of hydrogen.

According to an embodiment of the invention the silicon nitride in the particles of the modified electrode active material has a chemical formula of SiNₓ where 0.02≤x<0.9. By keeping the concentration of nitrogen low, i.e. lower than the atomic concentration of silicon, the capacity and conductivity of the modified electrode active material will be improved, whereby the initial lithiation of particles in the modified electrode active material will be easier to achieve when the modified electrode active material is used in a lithium-ion battery.

The initial lithiation of the modified electrode active material will leave lithium trapped both in certain states in the bulk, and at the surface of the particles. Increasing particle size will allow a reduction of the irreversible capacity related to the surface reaction. The bulk trapping of lithium is directly related to the amount of nitrogen in the particles, and by reducing the nitrogen content in the particles, first cycle irreversible capacity is reduced, while the cyclable capacity is increased. However, substantial decrease of the nitrogen will lead to diminished cycle life.

According to an embodiment of the invention the particles of the modified electrode active material comprise aggregates of individual particles comprising amorphous or crystalline, micro- or nano-sized stoichiometric or non-stochiometric silicon nitride where 0.02≤x<1.33, preferably in the range 1:0.02 to 1:0.9, whereby 0 to 30%, or 0-20%, or 0-10% of the atoms in the particles are replaced by one or more modifying elements selected from the group: phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb). According to an embodiment of the invention aggregates of individual particles have a minimum transverse dimension of 5 nm to 10 microns. It should be noted that while individual particles may be spherical, aggregated particles may have an irregular, non-spherical shape.

According to an embodiment of the invention the particles are at least partially coated with organic and/or inorganic material and comprised a core and at least one continuous or non-continuous shell. According to an embodiment of the invention at least one shell contains carbon. According to an embodiment of the invention the at least one shell comprises stoichiometric or non-stoichiometric silicon oxide.

According to an embodiment of the invention an electrode is prepared by casting a slurry formed by mixing particles of the modified electrode active material with a binder and conductive additive in water with or without pH adjustments on top of the current collector.

According to an embodiment of the invention the solids used for slurry preparation comprises at least 2 weight-%, at least 5 weight-%, at least 10 weight-%, at least 20 weight-%, at least 30 weight-%, at least 40 weight-%, at least 50 weight-% or at least 60 weight-% of the particles of the modified electrode active material.

According to an embodiment of the present invention, the modified electrode active material is lithiated or partially lithiated.

The present invention also concerns an electrical energy storage device that comprises a modified electrode active material according to any of the embodiments described herein, or at least one electrode, namely an anode, according to any of the embodiments of the invention.

According to an embodiment of the invention the electrical energy storage device may be a battery, such as a lithium-ion battery or a sodium-ion battery or a potassium-ion battery, that comprises an electrolyte with additives that enhances the first cycle lithiation or sodiation of the particles of the modified electrode active material, by providing a stable surface electrolyte interface layer that facilitates the lithiation or sodiation of the particles. According to an embodiment of the invention the electrolyte additive is at least one of the following: FEC (Fluoroethylene Carbonate), Vinylene Carbonate (VC).

In one embodiment of the invention, the electrical energy storage device comprises an electrolyte additive acting as a reactant which forms an SEI-layer aiding the lithium/sodium/potassium insertion. Fluoroethylene Carbonate (FEC) is used in pure silicon anodes to prevent cracking and degradation. The inventors propose to use FEC to form an intermediate layer where the electrochemical transition from Li ↔Li++e− can occur.

An electrode comprising the modified electrode active material according to any of the embodiments described herein may be produced using any suitable method. For example, the modified electrode active material may be produced by a method that comprises the steps of supplying a reactant gas containing silicon, a reactant gas containing nitrogen, and a reactant gas containing a modifying element, to a reaction chamber and heating the reactant gases to a temperature sufficient for thermal decomposition or reduction of the reactant gases to take place inside the reaction chamber, thereby producing particles by thermal decomposition. The method also comprises the step of arranging the produced particles in an electrode matrix, i.e. matter in which the particles are embedded, to produce an electrode, whereby the electrode exhibits at least one of the following: a) a chemical composition gradient, whereby the nitrogen content within the particles of the modified active material increases or decreases with distance from a surface of the electrode, b) a particle size gradient, whereby the average particle size of the particles of the modified active material increases or decreases with distance from a surface of the electrode, or c) a chemical composition gradient, whereby the other element content within the particles of the modified active material increases or decreases with distance from a surface of the electrode.

The method of preparation of the modified active material may be carried out in a plurality of batches using different techniques including, but not limited to a Free Space Reactor using a Chemical Vapour Deposition (CVD) process to produce the required particles having a plurality of different chemical compositions and/or particle sizes. CVD is a chemical process used to produce high-purity, high-performance solid materials. CVD needs to be conducted inside a reaction chamber, but the deposition itself occurs favorably at modified active material nuclei formed in the gas phase and not on the reactor walls. Alternatively, the nucleation particles could be supplied separately to CVD chamber. The powder formed has an amorphous or crystalline, a micro- or nano-sized structure depending on operating conditions. Alternatively, the process could be carried out using fluidized bed reactor.

Apart from US patent application no. US 2015/280222, there seem to be very few, if any, prior art documents that specify any advantages of using amorphous silicon rather than crystalline silicon. The amorphous material has a disadvantage in the wide distribution of energy states, leading to a reduction in energy efficiency of the battery—this is also known from amorphous carbon electrodes. The advantage of the amorphous material is that there is a multitude of diffusion paths available, and the clear two-phase behaviour seen in lithiation of crystalline silicon is removed. Cracks in silicon and silicon-based materials have namely been shown to be initiated from irregularities in the particle surface. The cracks then propagate along grain boundaries, or along preferred crystal orientations. By having particles with a smooth outer surface with amorphous structure, nano-sized and preferably a substantially spherical shape produced by abovementioned CVD method, the likelihood of producing suitable nucleation points for cracks is substantially reduced, thereby delaying cracking tendency, or increasing the particle size fluctuation that can be allowed before cracks are induced.

Large quantities of high purity amorphous or crystalline, micro- or nano-sized, stoichiometric or non-stochiometric particles having a particular particle size and having a narrow size distribution (i.e. substantially monodisperse) may thereby be produced in a controlled manner using the method described above. The method therefore provides a high yield of homogeneous particles whereby no extra step, such as size selection, is required to ensure that a desired standard deviation in particle size distribution is achieved. The produced particles comprise particles with a smooth surface, i.e. the particles have an outer surface that is free from irregularities, roughness and projections when viewed at a maximum resolution of a Scanning Electron Microscope (SEM), i.e. a spatial resolution less than 100 nm.

It should be noted that the expression “reactant gas” as used in this document need not necessarily mean that a reactant gas comprises just one gas. A reactant gas may comprise one or more silicon- or nitrogen-containing gases and even be mixed with one or more other gases, such as a modifying element-containing gas.

Additionally, the term “modifying element-containing gas” as used in this document refers to a gas that results in the production of a particles in which 0-10%, or 0-20%, or 0-30% of the nitrogen or silicon atoms in the particles are substituted with one or more modifying elements selected from the group: phosphorus (P), boron (B), carbon (C), oxygen (O), sulphur (S), selenium (Se), arsenic (As), tin (Sn), magnesium (Mg), aluminium (Al), iron (Fe), germanium (Ge) and/or antimony (Sb).

The method comprises the step of supplying a reactant gas containing one or more of the modifying elements selected from the group: phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb), to the reaction chamber. According to an embodiment of the invention the method comprises the step of controlling the concentration and/or flow of the at least one modifying element-containing gas so that less than 30% of the nitrogen or silicon atoms in the particles are substituted with phosphorus, boron, carbon, oxygen, sulphur, selenium, arsenic, tin, magnesium, aluminium, iron, germanium and/or antimony, thereby producing particles of the modified active material containing one or more modifying elements, i.e. from 0%, but not including 0%, up to 30%, or up to 20%, or up to 10%, or up to 5% of the atoms are substituted. The concentration of the modifying element in the particle can be up to 10 ppm, or up to 5 ppm or up to 1 ppm.

By producing particles of the modified active material containing one or more modifying elements, both the electron mobility and the lithium mobility can be improved when a modified electrode active material particles are used in an anode in a lithium-ion battery or a sodium-ion battery or a potassium-ion battery. The presence of one or more modifying elements namely mitigates conductivity issues associated with high nitrogen content in modified electrode active material and provides more options regarding the particle size selection. More specifically, this allows for the preparation of relatively large particles without sacrificing the performance at initial cycles when a conductive electrode is being formed.

The silicon-containing reactant gas may comprise at least one of the following: a silane having a chemical structure of SiₙH₂ₙ₊₂ where n is an integer number, a chlorosilane, dichlorosilane, trichlorosilane, or halide-substituted silanes having a chemical structure of SiₙH_{2n+2-y}HaI_{y}.

The nitrogen-containing reactant gas may comprise at least one of the following: ammonia, nitrogen.

The method may comprise the step of heating the reactant gases and the at least one other gas to a reaction temperature in the range of 400 to 1300° C. in the reaction chamber.

The method may comprise the step of pre-heating the reactant gases to a temperature below the reaction temperature, i.e. within 10° C., 20° C., 30° C., 40° C., 50° C., 60° C., 70° C., 80° C., 90° or 100° C. or more of the reaction temperature, in one or more pre-heating zones before the reactant gases are supplied to the reaction chamber. This has been found to improve size control probably as it results in providing a more homogeneous temperature in the reaction chamber and in the production of particles having a very narrow particle size distribution.

The method may comprise the step of moving the particles to a quench zone held at a temperature below 150° C., more preferably below 50° C., to quench the thermal decomposition process.

The method may comprise the step of exposing the particles to an oxygen-containing atmosphere, such as air, to provide the particles with a stochiometric or non-stochiometric silicon oxide shell. According to an embodiment of the invention the modified electrode active material may contain up to 10 atomic % of chemically bound hydrogen inside the particles.

The method may comprise the step of heat treating the particles after their production in an inert atmosphere or hydrogen-containing atmosphere so as not to oxidise the particles. By carrying out this optional post-processing step after the particle formation process, domains of silicon will nucleate within the particles. In the presence of substantial amounts of silicon, the domains will be linked together in a 3D-network. The post processing heat treating step may be conducted in-line with the particle formation method or as a separate batch processing step. The heat treatment may be conducted using infra-red (IR) heating element or standard resistance heating. Furthermore, the post-production heat treatment step may drive the hydrogen out of the produced particles and reorganize the particles.

The method may comprise the step of heating the particles after their production in the oxygen-containing atmosphere (i.e. annealing) therefore creating an oxide shell.

The method may comprise the step of at least partially coating the particles to obtain coated particles comprising a core and at least one continuous or non-continuous shell comprised of inorganic and/or organic material. Such partial or complete coating may be achieved using a CVD process step or through solution-based methods.

The method may comprise the step of mixing particles of the modified electrode active material with a binder and/or an electrically conductive additive before or as they are arranged to produce an electrode.

The particles may be coated with one of the following: graphite, amorphous carbon, or an organic or inorganic polymeric material.

The minimum transverse dimension of the particles is 100 nm-5 μm. The preparation of particles with a maximum transverse dimension above 100 nm (even above 1 μm) is highly desired to minimize the specific surface area of the modified electrode active material and therefore reduces the losses caused by SEI layer formation during the initial cycling.

### Definitions

An electrical energy storage device is any apparatus used for storing electrical energy that utilizes a reduction/oxidation reaction to convert electrical energy into chemical energy during charging and, conversely, chemical energy to electrical energy during discharging.

The electrode of an electrical energy storage device comprises a current collector which is usually constituted by a metal foil, such as a copper foil or an aluminum foil, and an electrode active material layer coated on a surface of the current collector. An electrode is the final product after a modified electrode active material with or without binder and conductive additive(s) has been applied to a current collector and dried and is ready for battery assembly

Of the electrodes in an electrochemical system, an anode is defined as an electrode on which an oxidation reaction happens, while a cathode is defined as an electrode on which a reduction reaction happens. For an electrochemical cell, the designations of the two electrodes change depending on whether the cell is charged or discharged; however, normal convention in battery technology is to designate the electrodes based on their function during discharge, as is used in the context of this document.

A current collector is used as an electron transfer channel for electrons formed in the electrochemical reactions of the electrical energy storage device to an external circuit to provide current. A current collector may also be called a “substrate”.

A binder is a material or substance that holds other materials together to form a cohesive whole by mechanical or chemical means. In a battery this entails holding the electrode material particles together, as well as holding this to the current collector.

Conductive additives are materials that are added to the electrodes to improve and maintain the electrical conductivity within the electrode, ensuring the necessary electrical connection between the active material particles and the current collector for the battery to function.

An active material in the context of the present document is a material that is directly involved in the electrochemical reaction itself, which results in energy release or storage. This is in contrast to passive materials which play a secondary role in the functioning of the device, e.g. binder and conductive additives, whose primary roles are to maintain the mechanical and electrical integrity of the electrodes, respectively.

In the present document, the modified electrode active material is the electrode active material layer coated/printed on a surface of a current collector. The expression “modified electrode active material” does not namely include the current collector of an electrode.

A stoichiometric compound is any chemical compound in which the numbers of atoms of the elements present in the compound can be expressed as a ratio of small integer numbers, e.g. Si₃N₄. Conversely, a nonstoichiometric compound, is any compound where this is not the case, either denoted as a deviation from a common stoichiometric compound, e.g. Si₃N₄₋ₓ, or as a simple ratio, e.g. SiNₓ. Nonstoichiometric compounds where this ratio is smaller or greater than the common stoichiometric ratio are called sub-stoichiometric or super-stoichiometric compounds, respectively.

An amorphous material is a solid material in which the positions of the atoms do not exhibit the property of long-range order, often termed translational periodicity, in contrast to a crystalline solid in which atomic positions exhibit this property.

Chemical vapor deposition (CVD) is parent to a family of processes whereby a solid material is deposited from a vapor by a chemical reaction occurring on or in the vicinity of a normally heated substrate surface. The resulting solid material is in the form of a thin film, powder, or single crystal.

Aggregates, in the context of this document, relate to particles that themselves are comprised of a number of smaller particles bound together by chemical or mechanical means, together forming a whole.

A nanomaterial is a natural, incidental or manufactured material containing particles, in an unbound state or as an aggregate or as an agglomerate and where, for 50% or more of the particles in the number size distribution, one or more external dimensions is in the size range 1 nm-100 nm.

The Solid Electrolyte Interphase (SEI) is a passivating layer that forms on the surface of electrode materials as a consequence of electrolyte constituents decomposing at electrochemical potentials present at the electrodes. The layer consists primarily of electrolyte decomposition products and plays a vital role in the stable operation of primarily Li-ion batteries.

An alloy is a substance composed of an intimate homogenous mix of two or more elements wherein one or more is a metal. The components of alloys cannot be separated using a physical means. In the context of the present document this term is used to describe silicon-based materials, as non-metal alloys or composites.

A current collector is used as an electron transfer channel for electrons formed in the electrochemical reactions of the electrical energy storage device to an external circuit to provide current. A current collector may also be called a “substrate”.

### BRIEF DESCRIPTION OF THE DRAWINGS

The present invention will hereinafter be further explained by means of non-limiting examples with reference to the appended schematic figures where;

FIG. 1a shows an electrode comprising modified electrode active material having a chemical composition gradient according to an embodiment of the invention,

FIG. 1b shows an electrode comprising modified electrode active material having a particle size gradient according to an embodiment of the invention,

FIG. 1c shows an electrode comprising modified electrode active material having a modifying element content gradient according to an embodiment of the invention,

FIG. 2 shows a coated particle,

FIG. 3 shows coated aggregated particles,

FIG. 4 shows coated aggregated particles each comprising a plurality of shells,

FIG. 5 is a graph of nitrogen content/particle size/modifying element content with thickness from a surface of a modified electrode active material according to an embodiment of the invention,

FIG. 6 shows an electrical energy storage device, namely a battery comprising a cathode, an anode according to an embodiment of the invention and electrolyte, and

FIG. 7 is a flow chart showing the steps of a method for producing an anode according to an embodiment of the invention.

It should be noted that the drawings have not necessarily been drawn to scale and that the dimensions of certain features may have been exaggerated for the sake of clarity. Furthermore, any feature described with reference to a particular embodiment of the invention may be utilized in any other embodiment of the invention unless this document explicitly excludes this possibility.

### DETAILED DESCRIPTION OF EMBODIMENTS

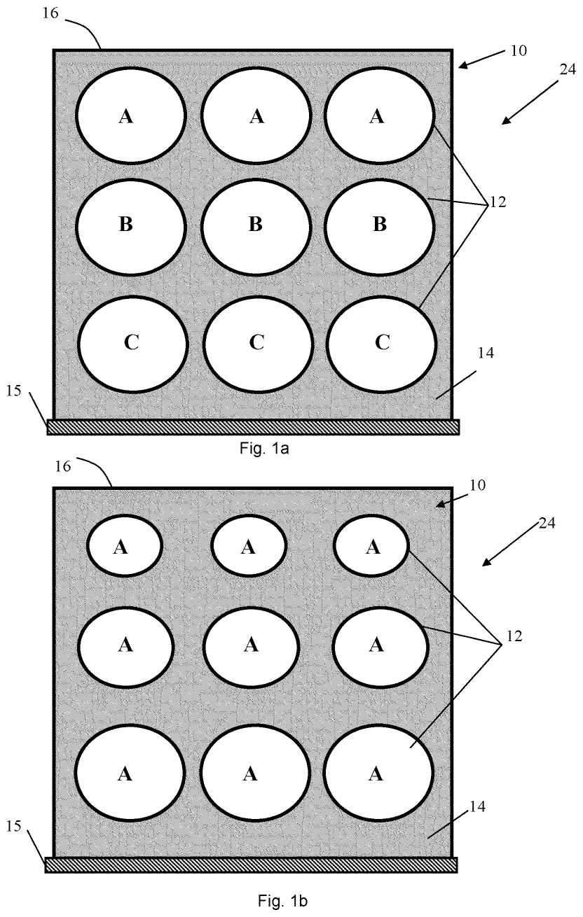

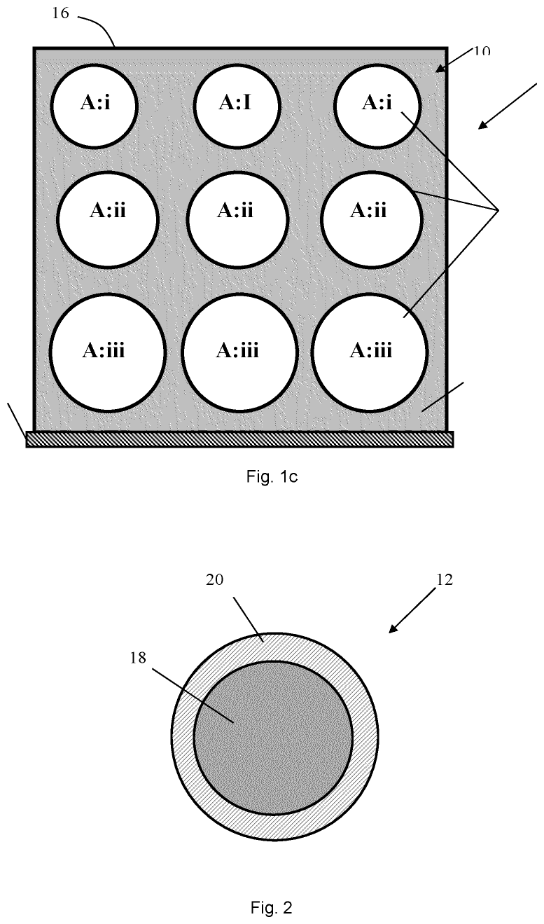

FIG. 1a shows an electrode 24 comprising a current collector 15 and an electrode active material layer 10 that is comprised of the modified electrode active material 12 in a matrix 14 that is coated/printed on a surface of the current collector 15. It should be noted that the electrode active material layer 10 need not necessarily be coated/printed on the entire surface of the current collector 15. Other methods for application of the active material could be utilized.

The modified electrode active material layer 10 contains a plurality of particles 12 comprising modified amorphous or crystalline, micro- or nano-sized stoichiometric or non-stochiometric silicon nitride. Each particle has one of three chemical compositions A, B or C. Chemical composition A may be SiNₓ₃A_{y}, chemical composition B may be SiNₓ₂A_{y}, and chemical composition C may be SiNₓ₁A_{y}, whereby x3≠x2≠x1, and A represent one or more modifying elements element.

0 to 30%, or 0-20% or 0-10% of the atoms of the modified electrode active material 12 contain one or more modifying elements I elements selected from the group: phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb). The particles 12 are mixed with a binder and optionally, one or more conductive additives of an electrode matrix 14 to form an electrode active material layer 10 that exhibits a chemical composition gradient, whereby the nitrogen content of each particle 12 decreases or increases with distance from a top surface 16 of the modified electrode active material 10. The top surface 16 is opposite to the side to which the current collector is connected in the illustrated embodiment.

It should be noted that the electrode active material layer 10 according to the present invention can contain any number of different chemical compositions from two or more.

Particles of the modified electrode active material 12 having the same chemical composition, namely A or B or C, are namely arranged in layers inside the electrode matrix 14 so that there will be a gradual or stepwise chemical composition gradient within the modified electrode active material 10.

The particles 12 may comprise silicon nitride in which the atomic ratio of silicon to nitrogen is in the range of 1:0.02 to 1:1.33.

In the illustrated embodiment the particles 12 have an average diameter or average maximum transverse dimension (if not spherical) in the range of 100 nm-5 μm, such as 200 nm, 300 nm, 400 nm, 0.5 μm, 1 μm, 2 μm, 3 μm, 4 μm or any other particle size from and including 100 nm and up to and including 5 μm, with no systematic particle size gradient in any direction.

In the illustrated embodiment, an electrode active material layer 10 having three distinct layers of modified electrode active material particles 12 is shown, each layer containing particles of the same chemical composition namely A or B or C. It should be noted that an electrode active material layer 10 can have any number of distinct layers, such as at least two layers, at least three layers, at least four layers, at least five layers, or at least ten layers.

It should also be noted that an electrode active material layer 10 according to an embodiment of the invention need not necessarily have distinct layers in which each layer contains particles of the same chemical composition namely A or B or C. A layer of the modified electrode active material 12 may comprise a plurality of particles 12 having two or more different chemical compositions as long as a chemical composition gradient is present with distance from a surface 16 of the modified electrode active material 10, i.e. an increasing or decreasing nitrogen content may be determined with distance from the surface 16 by determining an average nitrogen content at a plurality of distances from the surface 16 using conventional techniques for determining the chemical composition of particles 12 at different depths within the electrode active material layer 10

FIG. 1b shows an electrode active material layer 10 containing a plurality of particles 12 of modified electrode active material comprising amorphous or crystalline, micro- or nano-sized stoichiometric or non-stochiometric silicon nitride each having the same chemical formula A. The particles 12 are arranged inside an electrode matrix 14 so as to exhibit a particle size gradient, due to their different radii, whereby the particle size of the particles 12 increases with distance from a surface 16 of the electrode active material layer 10. It should be noted that the electrode active material layer 10 according to the present invention can contain particles 12 of modified electrode active material of any number of different sizes from two or more.

Particles 12 of modified electrode active material having the same chemical composition, A in the illustrated embodiment, are arranged in layers inside the electrode matrix 14 so that there will be a gradual or stepwise particle size gradient within the electrode active material layer 10. Alternatively, particles 12 of modified electrode active material having a plurality of different chemical compositions may be arranged in layers inside the electrode matrix 14 so that there will be a gradual or stepwise particle size gradient within the electrode active material layer 10.

It should also be noted that an electrode active material layer 10 according to an embodiment of the invention need not necessarily have distinct layers in which each layer contains particles of the same average particle size. A layer of particles 12 of modified electrode active material may comprise a plurality of particles 12 having two or more different particle sizes as long as an average particle size gradient is present with distance from a surface 16 of the electrode active material layer 10, i.e. an increasing or decreasing particle size may be determined with distance from the surface 16 by determining an average particle size at a plurality of distances from the surface 16 using conventional techniques for determining the average particle size at different depths within the electrode active material layer 10.

FIG. 1c shows an electrode active material layer 10 containing a plurality of particles 12 of modified electrode active material comprising amorphous or crystalline, micro- or nano-sized stoichiometric or non-stochiometric silicon nitride each having a chemical formula of A. The particles 12 of modified electrode active material are arranged inside an electrode matrix 14 so as to exhibit a modifying element content, whereby the total amount of one or more modifying elements in the electrode active material layer 10, represented by the amounts i, ii, and iii, increases with distance from a surface 16 of the electrode active material layer 10. It should be noted that the electrode active material layer 10 according to the present invention can contain any number of different modifying element contents from one or more. Furthermore, an increased/decreased content of one or more modifying elements does not necessarily change the size of the particles 12 of modified electrode active material. An electrode active material layer 10 according to the present invention can namely exhibit any number of the three different gradients a), b) and c) that are recited in claim 1, i.e. any one of them, any two of them, or all three of them.

It should also be noted that FIGS. 1a, 1b and/or 1c show electrode active materials layer containing only spherical particles 12 of modified electrode active material. An electrode active material layer 10 according to the present invention may comprise particles 12 of modified electrode active material having a plurality of different shapes whereby diameters (for spherical particles) or a maximum transverse dimensions (for non-spherical particles) are compared to determine whether a particle size gradient is present.

An electrode active material layer 10 according to an embodiment of the invention may exhibit a chemical composition gradient and/or a particle size gradient and/or a modifying element content gradient.

An electrode active material layer 10 according to the present invention may comprise at least 2 weight-%, at least 5 weight-%, at least 10 weight-%, at least 20 weight-%, at least weight-%, at least 40 weight-%, at least 50 weight-% or at least 60 weight-% of particles 12 of modified electrode active material.

The modified electrode active materials 12 shown in FIGS. 1a, 1 b and/or 1c may be used to form at least part of an anode, one or more of which may be included in an electrical energy storage device, such as a battery.

FIG. 2 shows a coated particle 12 of modified electrode active material comprising a core 18 and a continuous shell 20. An electrode active material layer 10 according to the present invention may comprise such continuously (or non-continuously) coated particles 12 of modified electrode active material or a mixture of (continuously or non-continuously) coated and uncoated particles 12 of modified electrode active material.

The particles 12 of modified electrode active material may contain one or more of the elements selected from the group: phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb). For examples, less than 30% of the nitrogen or silicon atoms in the particles 12 of modified electrode active material are substituted with phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb).

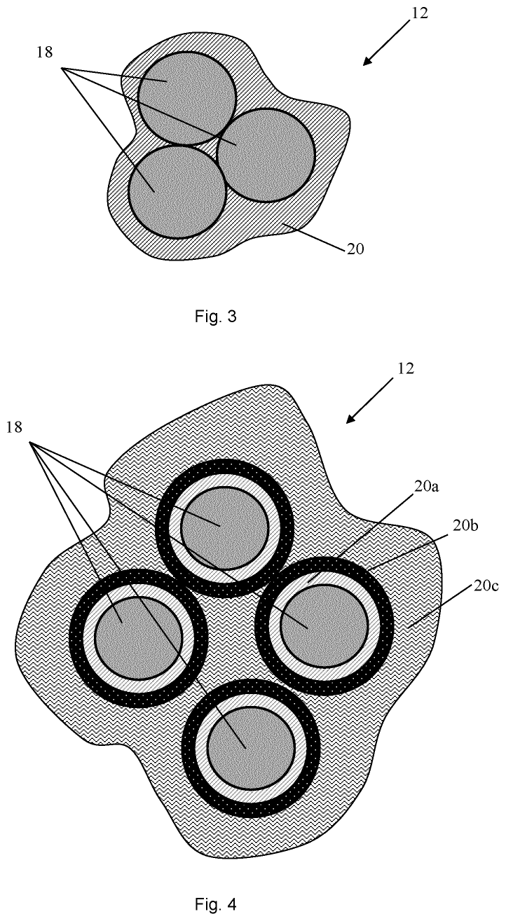

FIG. 3 shows a particle 12 of modified electrode active material that comprises an aggregate of three individual cores 18 comprising amorphous or crystalline, micro- or nano-sized stoichiometric or non-stochiometric silicon nitride in which 30% of the nitrogen or silicon atoms in the particles 12 of modified electrode active material are substituted with phosphorus (P), boron (B), carbon (C), oxygen (O), sulphur (S), selenium (Se), arsenic (As), tin (Sn), magnesium (Mg), aluminium (Al), iron (Fe), germanium (Ge) and/or antimony (Sb) and a continuous shell 20. The continuous shell 20 may be made of the same material as the electrode matrix 14.

FIG. 4 shows a particle 12 of modified electrode active material that comprises an aggregate of four continuously coated cores 18 comprising amorphous or crystalline, micro- or nano-sized stoichiometric or non-stochiometric silicon nitride in which 30% of the nitrogen or silicon atoms in the particles 12 of modified electrode active material are substituted with phosphorus (P), boron (B), carbon (C), oxygen (O), sulphur (S), selenium (Se), arsenic (As), tin (Sn), magnesium (Mg), aluminium (Al), iron (Fe), germanium (Ge) and/or antimony (Sb) each coated with a first continuous shell 20a and a second continuous shell 20b which are coated with a third continuous shell 20c.

At least some of the particles 12 of the modified electrode active material 10 according to the present invention may be at least partially coated with one or more organic and/or inorganic materials. At least one shell 20 may contain carbon.

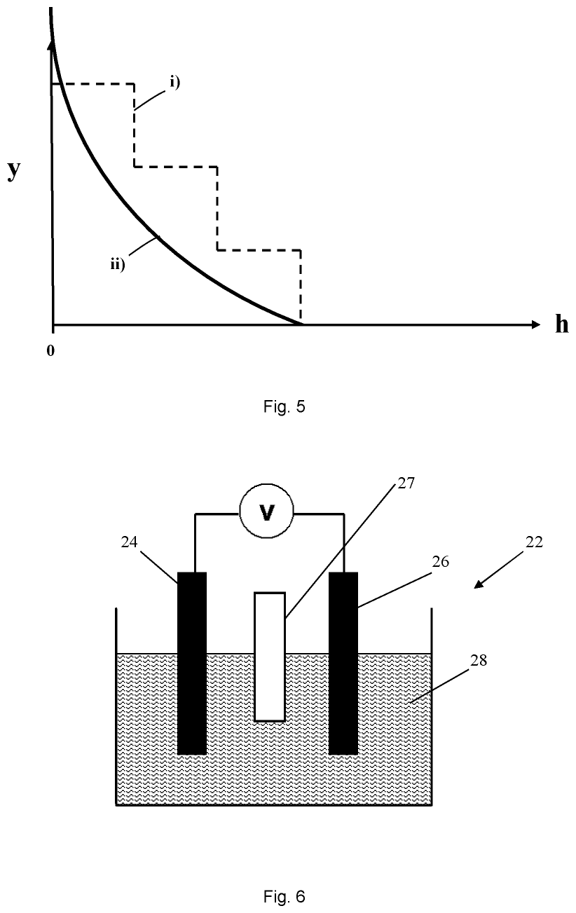

FIG. 5 is a graph where the thickness, h, of an electrode active material layer 10 according to an embodiment of the invention is plotted on the x-axis and one of the following is plotted on the y-axis:
a) nitrogen content in the particles 12 of the modified electrode active material,
b) the average particle size of the particles 12 of the modified electrode active material, or
c) the modifying element content gradient of the particles 12 of the modified electrode active material.

The dashed line i) shows a stepwise decrease of the nitrogen content/particles size/modifying element content with thickness h from a surface of the electrode active material layer (where h=0 at said surface). Such a stepwise gradient may contain any number of steps from two or more, and may increase or decrease in either direction. The solid line ii) shows a gradual decrease of the nitrogen content/average particle size/modifying element content with thickness h from a surface of the electrode active material layer, which may increase or decrease in either direction.

FIG. 6 shows a battery 22 comprising an anode 24 comprising a modified electrode active material 12 according to an embodiment of the invention. The battery 22 also comprises a cathode 26 and electrolyte 28. Optionally, an electrical energy storage device according to the present invention may contain a separator 27.

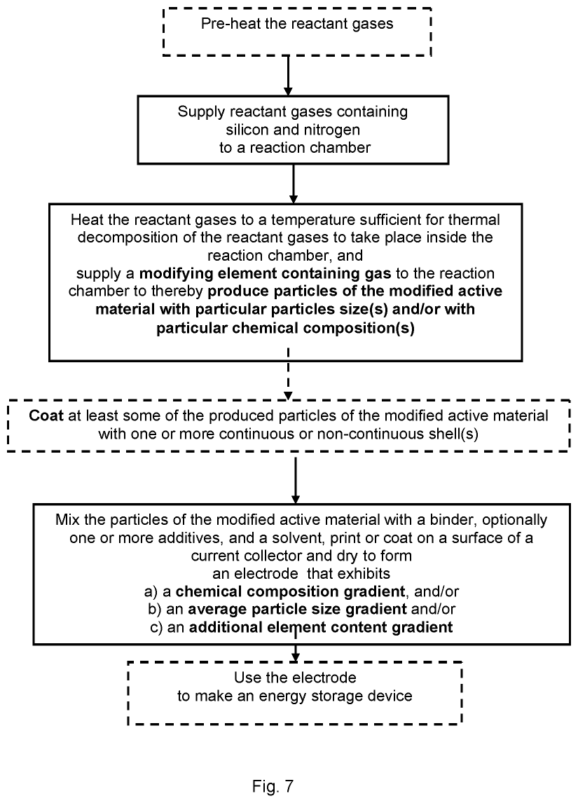

FIG. 7 shows the steps of a method for producing an electrode active material layer 10 containing a plurality of particles comprising amorphous or crystalline, micro- or nano-sized stoichiometric or non-stochiometric silicon nitride each having the chemical formula according to an embodiment of the invention in which non-essential method steps are shown with dashed boxes.

The method comprises the steps of supplying a reactant gas containing silicon, such as a silane having a chemical structure of SiₙH₂ₙ₊₂ where n is an integer number, a chlorosilane, dichlorosilane, trichlorosilane, and/or halide-substituted silanes having a chemical structure of SiₙH_{2n+2-y}HaI_{y}, a reactant gas containing nitrogen, ammonia and/or nitrogen, to a reaction chamber and heating the reactant gases to a temperature sufficient for thermal decomposition or reduction of the reactant gases to take place inside the reaction chamber, thereby producing particles by thermal decomposition.

The method according to the present invention may be controlled to produce particles that have the same chemical composition and/or the same particle size by conducting the method using the same reagents and the same reaction chamber conditions, throughout the production of particles. The method may then be repeated one or more times using different reagents and/or production conditions to produce particles having a different chemical composition and/or different particle size. Alternatively, the reagents and reaction chamber conditions may be changed during the particle production process.

The method comprises the step of supplying at least one modifying element-containing gas containing one or more of the elements selected from the group: phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb), to the reaction chamber and controlling the concentration and/or flow of the at least one modifying element-containing gas so that less than 30%, or less than 20% or less than 10% of the nitrogen or silicon atoms in the particles are substituted with phosphorus, boron, carbon, oxygen, sulphur, selenium, arsenic, tin, magnesium, aluminium, iron, germanium and/or antimony.

Optionally, the method comprises the step of pre-heating the reactant gases and at least one modifying element-containing gas (if one or more modifying element-containing gases are used) to a temperature below the reaction temperature in one or more pre-heating zones before the reactant gases are supplied to the reaction chamber.

The thermal decomposition or reduction of the reactant gases inside the reaction chamber may be influenced by changing at least one of the following characteristics of the reactant gas and/or a modifying element-containing gas: temperature, pressure, flow rate, heat capacity, composition, modifying element type(s), and/or amount(s) and/or concentration of one or more components of the gases. By changing at least one of the characteristics of the reactant gases and/or a modifying element-containing gas, the thermal decomposition or reduction of the reactant gas inside the reaction chamber, and consequently the formation and/or growth of particles, and/or their morphology and/or crystallinity, may be controlled in order to obtain a final product having the desired characteristics.

Alternatively, a range of different chemical compositions and/or different particle sizes may be produced in a single run by altering the reagents and/or production conditions during the production of particles. The thermal decomposition or reduction of the reactant gases inside a reaction chamber may for example be controlled by adjusting the temperature, pressure, flow rate, heat capacity and/or composition, of the reactant gases (and/or a modifying element-containing gas). The produced particles of modified electrode active material having different chemical compositions and/or particles sizes may then be sorted according to their particular chemical composition and/or particular particle size during their production by collecting the produced particles at different times during their production depending on the prevailing reagents being used and production conditions.

Optionally, particles of modified electrode active material may be sorted into batches of the same chemical composition or particle size using a conventional filtering technique, in which particles are filtered into separate batches according to their particle size (since a particular chemical composition also results in particles having a particular size). Repeating the method according to the present invention is not therefore necessary to produce a plurality of particles having at least two different chemical compositions and/or particle sizes.

The method may also comprise the step of moving the produced particles to a quench zone held at a temperature below 150° C., more preferably below 50° C., to quench the thermal decomposition process.

The method may also comprise the step of exposing the produced particles to an oxygen-containing atmosphere to provide the particles with a stochiometric or non-stochiometric silicon oxide shell.

The method may also comprise the step of annealing the produced particles in an oxygen-containing atmosphere to provide the particles with a stochiometric or non-stochiometric silicon oxide shell.

The method may also comprise the step of annealing the produced particles in an oxygen-free atmosphere.

The method may also comprise the step of at least partially coating the particles to obtain coated particles comprising a core and at least one continuous or non-continuous shell comprised of inorganic and/or organic material. A coating step may be carried out inside the same reactor used for the production of the particles, or inside a different vessel.

The method may be used to produce a high volume of particles, it is easy to scale up and it is possible to achieve continuous particle production while the reactor is in use. Particles of modified electrode active material having different chemical compositions and/or different particles sizes are namely prepared.

The particles may optionally be mixed with a binder, optionally at least one additive, and a solvent, such as water, printed or coated on a surface of a current collector and then dried.

The produced particles may be mixed with a binder and/or an electrically conductive additive before or as they are arranged in an electrode matrix.

The particles are then arranged in an electrode matrix, such as graphite, an organic or inorganic polymeric material or any other suitable electrode matrix, so that the modified electrode active material exhibits a) a chemical composition gradient, whereby the nitrogen content within the particles increases or decreases with distance from a surface of the material, b) a particle size gradient, whereby the average particle size of the particles increases or decreases with distance from a surface of the material, or c) a chemical composition gradient, whereby the content of a modifying element(s) within the particles increases or decreases with distance from a surface of the material.

Optionally, the modified electrode active material may be used to produce an electrode for an electrical energy storage device, such as a battery, for example a lithium-ion battery. By using such modified electrode active material instead of graphite in a lithium-ion battery, or at least replacing part of the graphite with such a modified electrode active material, the storage capacity of the battery can be substantially increased.

An electrical energy storage device may comprise a cathode, an anode comprising a modified electrode active material according to an embodiment of the invention, an electrolyte and optionally, a separator. The anode may be fabricated using slurry-based processing, where the particles are mixed with a binder and an electrically conductive additive.

### Example

Nanoparticles of silicon nitride were prepared using a free space CVD reactor using silane, ammonia and phosphine as precursors. The free space reactor (FSR) was constructed using a stainless-steel tube with a diameter of 50 mm and having multiple heating zones, allowing gradual heating of the silane, ammonia and phosphine gases needed for undisturbed flow. Upon passing the heating zone, the formed silicon nitride particles were driven into a cold zone kept at a temperature of 10° C. to quench the pyrolysis process.

The formation of the silicon nitride particles was verified through an optical window in the wall of the reactor located downstream of the quenching zone which was illuminated with a broadband light source. The formation of the silicon nitride particles was recorded with a camera. Upon completion of the pyrolysis process, the FSR was flushed with argon gas to ensure the complete removal of silane gas. The system was then opened, and the silicon nitride particles were collected.

The produced silicon nitride particles had a chemical composition of SiN_{0.8}, were spherical and had a diameter of 0.5 μm.

Electrodes were made with 60 weight-% of the silicon nitride nanoparticles, 15 weight-% carbon black, 10 weight-% graphite and 15 weight-% binder (CMC). Alternative embodiments may include platelets of stoichiometric or non-stoichiometric silicon nitride with the smallest of dimensions between 5 nm and 10 microns.

Further modifications of the invention within the scope of the claims would be apparent to a skilled person.

1. Electrode (24) for an electrical energy storage device, which electrode (24) comprises an electrode active material layer (10) containing a plurality of particles of a modified electrode active material (12) comprising amorphous or crystalline, micro- or nano-sized stoichiometric or non-stochiometric silicon nitride each having a chemical formula of SiNₓ whereby 0 to 30%, or 0 to 20%, or 0 to 10% of atoms in said particles (12) contain one or more modifying elements selected from the group: phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb), characterized in that said particles (12) are arranged in a conductive electrode matrix (14) so as to exhibit at least one of the following: a) a chemical composition gradient, whereby the nitrogen content within the particles (12) increases or decreases with distance from a surface (16) of said modified electrode active material (10), b) a particle size gradient, whereby the average particle size of the particles (12) increases or decreases with distance from a surface (16) of said modified electrode active material (10), and/or c) a chemical composition gradient, whereby said modifying element content changes through the thickness of the modified electrode active material (10).

2. Electrode (24) according to claim 1, characterized in that said particles (12) comprise spherical particles of a modified electrode active material (12) having an average diameter of 100 nm-5 μm.

3. Electrode (24) according to claim 1 or 2, characterized in that said electrode active material layer (10) comprises particles of a modified electrode active material (12) having an anisotropic shape with an average minimum transverse dimension of 100 nm-5 μm.

4. Electrode (24) according to any of the preceding claims, characterized in that said electrode active material layer (10) comprises particles of a modified electrode active material (12) having a rod-like shape wherein the minimum transverse dimension of the particles is 100 nm-5 μm.

5. Electrode (24) according to any of the preceding claims, characterized in that it comprises particles of a modified electrode active material (12) in the form of platelets wherein the thickness of the particles is 100 nm-2 μm.

6. Electrode (24) according to any of the preceding claims, characterized in that it comprises particles of a modified electrode active material (12) in which the atomic ratio of silicon to nitrogen is in the range of 1:0.02 to 1:1.33.

7. Electrode (24) according to any of the preceding claims, characterized in that it comprises particles of a modified electrode active material (12) which contain up to 10 atomic % of hydrogen.

8. Electrode (24) according to any of the preceding claims, characterized in that said particles of a modified electrode active material (12) comprise aggregates of individual particles (12) comprising modified amorphous or crystalline, micro- or nano-sized stoichiometric or non-stochiometric silicon nitride

9. Electrode (24) according to any of the preceding claims, characterized in that said particles of a modified electrode active material (12) are at least partially coated with organic and/or inorganic material and comprised a core (18) and at least one continuous or non-continuous shell (20, 20a, 20b, 20c).

10. Electrode (24) according to claim 9, characterized in that said at least one shell comprises stoichiometric or non-stoichiometric silicon oxide.

11. Electrode (24) according to claim 9, characterized in that said at least one shell (20, 20a, 20b, 20c) contains carbon.

12. Electrode (24) according to any of the preceding claims, characterized in that said electrode active material layer (10) comprises at least 2 weight-% of said particles of a modified electrode active material (12).

13. Electrode (24) according to any of the preceding claims, characterized in that said electrode active material layer (10) is at least partly lithiated.

14. An electrical energy storage device comprising a cathode, an anode and electrolyte, characterized in that said anode is an electrode (24) according to any of the preceding claims.

15. An electrical energy storage device according to claim 14, characterized in that it is a lithium-ion battery, a sodium-ion battery, or a potassium-ion battery.

16. Method for producing an electrode according to any of claims 1-13, comprising the steps of supplying a reactant gas containing silicon, a reactant gas containing nitrogen, and a reactant gas containing a modifying element, to a reaction chamber and heating the reactant gases to a temperature sufficient for thermal decomposition or reduction of the reactant gases to take place inside the reaction chamber, thereby producing particles by thermal decomposition, characterized in that it comprises the step of arranging the produced particles in an electrode matrix to produce an electrode, whereby the electrode exhibits at least one of the following: a) a chemical composition gradient, whereby the nitrogen content within the particles of the modified active material increases or decreases with distance from a surface of the electrode, b) a particle size gradient, whereby the average particle size of the particles of the modified active material increases or decreases with distance from a surface of the electrode, or c) a chemical composition gradient, whereby the other element content within the particles of the modified active material increases or decreases with distance from a surface of the electrode.

17. Method according to claim 16, characterized in that said modifying element is one or more of the elements selected from the group: phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb).

18. Method according to claim 16, characterized in that it comprises the step of controlling the concentration and/or flow of the at least one modifying element-containing gas so that less than 30% of the nitrogen or silicon atoms in the particles are substituted with phosphorus (P), boron (B), carbon (C), oxygen (O), sulphur (S), selenium (Se), arsenic (As), tin (Sn), magnesium (Mg), aluminium (Al), iron (Fe), germanium (Ge) or antimony (Sb), thereby producing particles of the modified active material containing one or more modifying elements, i.e. from 0%, but not including 0%, up to 30%.

19. Method according to any of claims 16-18, characterized in that it comprises the step of heating the reactant gases and the at least one other gas to a reaction temperature in the range of 400 to 1300° C. in the reaction chamber.

20. Method according to any of claims 16-19, characterized in that it comprises the step of pre-heating the reactant gases to a temperature below the reaction temperature in one or more pre-heating zones before the reactant gases are supplied to the reaction chamber.

21. Method according to any of claims 16-20, characterized in that it comprises the step of moving the particles to a quench zone held at a temperature below 150° C., more preferably below 50° C., to quench the thermal decomposition process.

22. Method according to any of claims 16-21, characterized in that it comprises the step of exposing the particles to an oxygen-containing atmosphere, such as air, to provide the particles with a stochiometric or non-stochiometric silicon oxide shell.

23. Method according to any of claims 16-22, characterized in that it comprises the step of heat treating the particles after their production in an inert atmosphere or hydrogen-containing atmosphere so as not to oxidise the particles.

24. Method according to any of claims 16-23, characterized in that it comprises the step of heating the particles after their production in an oxygen-containing atmosphere to create an oxide shell.

25. 23. Method according to any of claims 16-24, characterized in that it comprises the step of at least partially coating the particles to obtain coated particles comprising a core and at least one continuous or non-continuous shell comprised of inorganic and/or organic material.

26. Method according to any of claims 16-24, characterized in that it comprises the step of mixing particles of the modified electrode active material with a binder and/or an electrically conductive additive before or as they are arranged to produce an electrode.
